(19) United States
(12) Patent Application Publication
(10) Pub. No.: US 2026/0094262 A1
(43) Pub. Date: Apr. 2, 2026

(54) Semiconductor Processing Based on Image Data

(71) Applicant: GDM Holding LLC, Mountain View, CA (US)

(72) Inventor: Abdalaziz I.M. Awad, Mountain View, CA (US)

(21) Appl. No.: 19/339,420

(22) Filed: Sep. 25, 2025

Related U.S. Application Data
(60) Provisional application No. 63/701,758, filed on Oct. 1, 2024.

(51) Int. Cl. G06T 7/00; G06T 3/02; G06T 5/70; G06T 7/13; G06T 7/33; G06T 11/40

(52) U.S. Cl. CPC G06T 7/001; G06T 3/02; G06T 5/70; G06T 7/13; G06T 7/337; G06T 11/40; G06T 2207/10061; G06T 2207/20081; G06T 2207/30148

(57) ABSTRACT

The technology involves processing of image data. According to one aspect, a method includes receiving SEM image data associated with a fabricated semiconductor wafer and a target photomask design associated with the fabricated semiconductor wafer. First contours are extracted from the SEM image data and second contours are extracted from the target photomask design. A first flood-fill is generated based on the first contours and first seeds based on the second contours. A second flood-fill is generated based on the first contours and second seeds based on the first flood-fill. A difference between a combination of the first and second flood-fills, and the first contours is determined.

### CROSS REFERENCE TO RELATED APPLICATIONS

The present application claims the benefit of and priority to U.S. Provisional Application No. 63/701,758, filed Oct. 1, 2024, the entire disclosure of which is hereby incorporated herein by reference.

### BACKGROUND

Improving semiconductor processes and systems, and increasing yield from semiconductor processes and systems, may include modeling of many, if not all, processing steps associated with these semiconductor processes and systems. One such semiconductor process is lithography. Non-limiting examples of lithography processing steps include exposure, resist development, and mask-writing. Existing approaches may be subject to noise, shadows, asymmetric edges and other lithography-related issues.

### SUMMARY

Improving efficiency and scalability of modeling of lithography processing steps can enable deployment of suitable models in integrated full-chip applications. In some approaches, errors in mask-writing are resolved using biases or corrections for a mask-writing tool. Aspects of the technology disclosed herein include machine learning based modeling of one or more lithography processing steps that provides improved efficiency and scalability of modeling those lithography processing steps. The technical benefits of models according to the technology include these models being differentiable, which can enable integration of these models with modeling of other lithography processing steps. This integration can, for instance, facilitate end-to-end mask optimization while eliminating some, if not most or all, mask rule check (MRC) requirements. This integration can, for instance, provide improved efficiency of design space exploration for mask optimizations.

Aspects of the technology include processing (e.g., analysis and/or manipulation) of image data. By way of example, image data, such as scanning electron microscope (SEM) image data, can be denoised. Contours of features of a mask formed on a wafer can be extracted from semiconductor wafer image data, denoised or not. These extracted contours can be converted to a binary representation or format. These extracted contours can be aligned with the semiconductor wafer image data, relative to a target photomask design.

The technical benefits of the disclosed technology include enabling direct comparison of target photomask designs to fabricated (e.g., printed) features of a wafer. Some other approaches utilize known lithography fidelity metrics that apply only to rectilinear feature geometries, such as lines, spaces and contact hole patterns. Advantageously, the disclosed technology provides efficient and differentiable metrics that are applicable to multiple, if not all types of feature geometries. Moreover, the technical benefits of the disclosed technology include enabling use of metrics to quantify errors, such as mean squared error (MSE), which can enable differentiable optimizations and machine learning based models to be based on (e.g., “be aware of”) target metrics, and values thereof, to be satisfied.

Lithography models can predict manufacturing behavior of one or more lithography processing steps on silicon wafer. Thus, quantification of the quality, or fidelity, of this manufacturing behavior can be used to validate lithography models and calibrate lithography models to manufacturing data (e.g., printed wafer data). Some other approaches use metrics such as critical dimension errors and edge placement errors to quantify lithography performance and validate lithography models. However, these other approaches lack generalization to other, more sophisticated, feature geometries than rectilinear feature geometries, such as lines, spaces and contact hole patterns. Moreover, metrics used by these other approaches, such as edge placement error, are non-differentiable and incompatible with computer vision techniques. Thus, use of machine learning loss functions that accurately capture the quality of manufacturing behavior (e.g., printing) by these other approaches is inhibited or impossible.

Additional technical benefits of the disclosed technology include resolving challenges associated with noise in SEM image data of semiconductor wafers, and alignment and registration of SEM image data of semiconductor wafers with a target photomask design. Aspects of the technology include converting SEM image data and/or a target photomask design to a binary raster space. Computer vision techniques are used, with the SEM image data and target photomask design, to align the SEM image data with the target photomask design.

Aspects of the technology include automated pre-processing SEM images (also referred to herein as SEM image data) of a mask formed on a wafer, and converting these pre-processed SEM images to filled contour images for comparison to target photomask designs. This pre-processing of SEM images can include a denoising step followed by a contour extraction step. The contour extraction step can be followed by an overlay matching step to align contours extracted from the SEM images to contours extracted from the target photomask designs. The pre-processing of SEM images can be followed by flood-filling steps to convert the hollow and possibly disconnected extracted contours into binarized SEM polygons that can be directly and precisely compared to target photomask designs. The technical benefits of the disclosed technology include enabling generalization and prediction of mask behavior at various resolutions and/or length scales. Moreover, the approaches disclosed herein can be utilized as a general solution for any type of mask-writing tool.

A machine learning model can be trained using target photomask designs as inputs, and SEM image data of wafers, and masks formed thereon, as outputs. This model can then be used for circuit design and fabrication.

According to one aspect of the technology, a method includes receiving, by one or more processors, SEM image data associated with a fabricated semiconductor wafer; receiving, by the one or more processors, a target photomask design associated with the fabricated semiconductor wafer; extracting, by the one or more processors, first contours from the SEM image data and second contours from the target photomask design; generating, by the one or more processors, a first flood-fill based at least on the first contours and first seeds, the first seeds being based at least on the second contours; generating, by the one or more processors, a second flood-fill based at least on the first contours and second seeds, the second seeds being based at least on the first flood-fill; and determining, by the one or more processors, a difference between a combination of the first and second flood-fills, and the first contours.

In an example, extracting the first contours may include denoising the SEM image data. The denoised SEM image data may be converted to a binary format, and a border following approach may be applied to that converted, denoised SEM image data.

Alternatively or additionally to the above, generating the first flood-fill may include aligning the first contours with the second contours. Here, the first flood-fill may be generated further based at least on these aligned first contours.

Alternatively or additionally to the above, generating the first flood-fill may include generating the first seeds by eroding the target photomask design.

Alternatively or additionally to the above, generating the second flood-fill may include generating the second seeds by eroding an affine transformation of the target photomask design based at least on the first flood-fill.

Alternatively or additionally to the above, generating the first flood-fill may include generating the first seeds by eroding, based at least on a first kernel, the target photomask design, and generating the second flood-fill may include generating the second seeds by eroding, based at least on a second kernel, an affine transformation of the target photomask design based at least on the first flood-fill. Here, the second kernel may be smaller than the first kernel. The second kernel may be smaller than the first kernel by a selected amount.

Alternatively or additionally to the above, determining the difference may include applying an affine transformation to the combination of the first and second flood-fills.

Alternatively or additionally to the above, the method may include training, based at least on the determined difference, a machine learning model to adjust the target photomask design.

Alternatively or additionally to the above, the method may include adjusting, based at least on the determined difference, the target photomask design.

According to another aspect of the technology, a system is provided that comprises memory configured to store at least one of SEM image data associated with a fabricated semiconductor wafer and a target photomask design associated with the fabricated semiconductor wafer, and one or more processors operatively coupled to the memory. The one or more processors are configured to: extract first contours from the SEM image data and second contours from the target photomask design; generate a first flood-fill based at least on the first contours and first seeds, the first seeds being based at least on the second contours; generate a second flood-fill based at least on the first contours and second seeds, the second seeds being based at least on the first flood-fill; and determine a difference between a combination of the first and second flood-fills, and the first contours.

In an example, the one or more processors may be configured to extract the first contours by being configured to denoise the SEM image data. The denoised SEM image data may be converted to a binary format, and a border following approach may be applied to that converted, denoised SEM image data.

Alternatively or additionally to the above, the one or more processors may be further configured to align the first contours with the second contours. Here, the first flood-fill may be generated further based at least on these aligned first contours.

Alternatively or additionally to the above, the one or more processors may be further configured to generate the first seeds by erosion of the target photomask design.

Alternatively or additionally to the above, the one or more processors may be further configured to generate the second seeds by erosion of an affine transformation of the target photomask design based at least on the first flood-fill.

Alternatively or additionally to the above, the one or more processors are further configured to: generate the first seeds by erosion, based at least on a first kernel, of the target photomask design, and generate the second seeds by erosion, based at least on a second kernel, of an affine transformation of the target photomask design based at least on the first flood-fill. Here, the second kernel may be smaller than the first kernel. The second kernel may be smaller than the first kernel by a selected amount.

Alternatively or additionally to the above, the one or more processors may be configured to determine the difference by being configured to apply an affine transformation to the combination of the first and second flood-fills.

Alternatively or additionally to the above, the one or more processors may be further configured to train, based at least on the determined difference, a machine learning model to adjust the target photomask design.

Alternatively or additionally to the above, the one or more processors may be further configured to adjust, based at least on the determined difference, the target photomask design.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 illustrates an integrated circuit design flow in accordance with aspects of the technology.

FIG. 2 illustrates an example system that may be employed with aspects of the technology.

FIGS. 3A-B illustrate an example of a target photomask design and an example of SEM image data of a semiconductor wafer in accordance with aspects of the technology.

FIGS. 4A-B illustrate an example of SEM image data of a semiconductor wafer and an example of contours of features of that semiconductor wafer extracted from that SEM image data in accordance with aspects of the technology.

FIGS. 5A-B illustrate an example of a smoothed target photomask design and an example of contours of features of that semiconductor wafer extracted from that smoothed target photomask design in accordance with aspects of the technology.

FIGS. 6A-B illustrate an example of an overlay of contours extracted from SEM image data of a semiconductor wafer and contours extracted from a target photomask design in accordance with aspects of the technology.

FIGS. 7A-B illustrate an example of an overlay of contours extracted from SEM image data of a semiconductor wafer and contours extracted from a target photomask design that have been aligned with that target photomask design in accordance with aspects of the technology.

FIGS. 8A-B illustrate an example of an aligned target photomask design and an example of an eroded target photomask design in accordance with aspects of the technology.

FIG. 9 illustrates an example of an overlay of contours extracted from SEM image data of a semiconductor wafer and an eroded target photomask design.

FIG. 10 illustrates an example of a flood-fill operation based on contours extracted from SEM image data of a semiconductor wafer in accordance with aspects of the technology.

FIGS. 11A-C illustrate an example of a photomask design, an example of a flood-fill, and an example of an affine-transformation of the photomask design in accordance with aspects of the technology.

FIG. 12 illustrates an example of a comparison of an affine-transformed target photomask design to contours extracted from SEM image data in accordance with some other approaches.

FIG. 13 illustrates an example of a comparison of an aligned target photomask design to contours extracted from SEM image data in accordance with aspects of the technology.

FIGS. 14A-B illustrate an example of a first flood-fill and an example of an overlay of an eroded version of an affine-transformed target photomask design and contours extracted from SEM image data in accordance with aspects of the technology.

FIG. 15 illustrates an example of a combination of a first flood-fill and a second flood-fill in accordance with aspects of the technology.

FIG. 16 illustrates an example of a comparison of a first flood-fill and a second flood-fill in accordance with aspects of the technology.

FIG. 17 illustrates an example of a photomask raster design in accordance with aspects of the technology.

FIG. 18 illustrates an example of an overlay of a combination of a first flood-fill and a second flood-fill, and a footprint of a photomask design in accordance with aspects of the technology.

FIG. 19 illustrates an example of an affine transformation of a second flood-fill in accordance with aspects of the technology.

FIG. 20 illustrates an example method in accordance with aspects of the technology.

### DETAILED DESCRIPTION

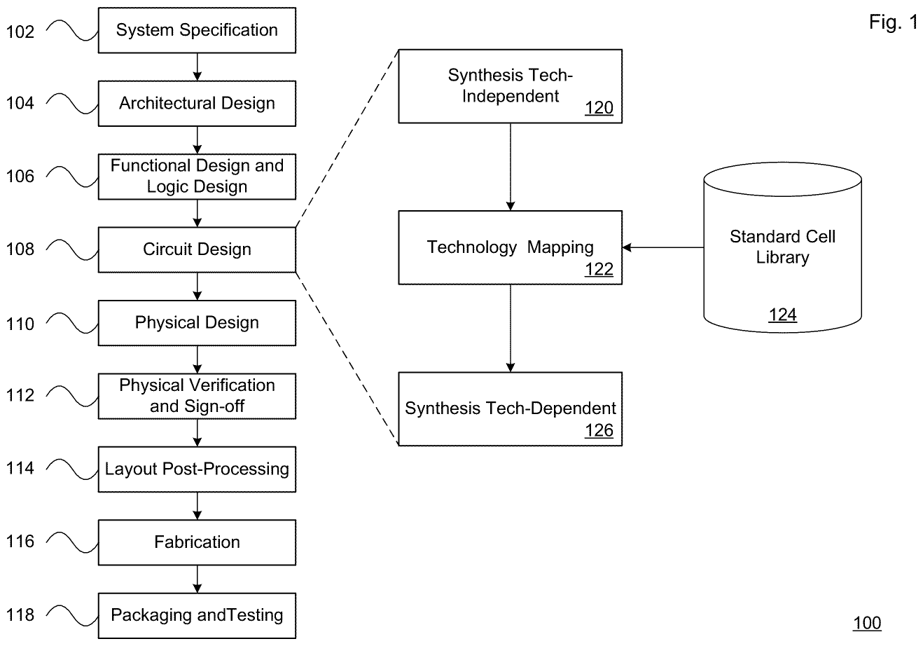

FIG. 1 illustrates an exemplary integrated circuit design flow 100 for use with aspects of the technology, including generating a circuit design and/or fabricating an integrated circuit that incorporates semiconductor processing based on image data. As shown, the design flow may include preparing a system specification at block 102, such as to identify system-level requirements for the integrated circuit. The system specification is intended to capture the overall goal of the desired integrated circuit. This may include determining the device's cost, performance, general architecture, how off-chip communication will be conducted, etc. The process flow may also include performing architectural design at block 104. At this stage, the design's architecture and its layout are determined by design engineers. This can include integration of memory management, analog and/or mixed-signal components, on-device and external communication, any power constraints, choice of process technology and/or layer stacks, etc.

The process flow continues with performing functional design and logic design at block 106, and performing circuit design at block 108. Functional design may include refinement of the design's specification to achieve the functional behavior of the desired system. Logic design involves adding the design's structure to a behavioral representation of the desired design. Here, considerations include logic minimization, performance enhancement, as well as testability. This stage may consider problems associated with test vector generation, error detection and correction, and the like. By way of example, the functional design and logic design may include generating a behavioral model description (e.g., using HDL) and floor-planning. During circuit design, logic blocks are replaced by corresponding electronic circuits, which may include devices such as resistors, capacitors, and/or transistors. At this stage, circuit simulation may be performed in order to verify timing behavior and other constraints of the system. A Spice tool or other program may be used for circuit simulation.

Once the circuit design is complete, physical design may be performed at block 110 (e.g., component and wiring placement and routing), followed by physical verification and sign-off at block 112 (e.g., to obtain GDSII information with shapes to form the masks used to create the layers for fabricating the integrated circuit). During physical design, the actual layout of the integrated circuit is performed. Here, all of the components are placed and interconnected using metal interconnections. During this stage, the system may perform optimization of curvilinear interconnects, alternatively or additionally to any other layout operations. A circuit design that is able to pass testing of a circuit simulator in the circuit design stage may be found to be faulty after it has been packaged, e.g., due to geometric design rule issues. Thus, physical design rules are followed to ensure correctness during chip fabrication. Errors may include short or open circuits, open channels, or other issues may result when physical design rules are not followed. During physical verification and sign-off, the system performs any verification steps that are required before chip manufacturing. This can include design rule checking and correction, timing simulation, electromagnetic simulation, etc.

Layout post-processing occurs at block 114, then fabrication at block 116, and the packaging and testing at block 118. At block 114, the layout post-processing may include geometry processing before actual manufacturing, e.g., any dummy fill insertion, correction for optical proximity, mask optimization, etc. Fabrication comprises semiconductor manufacturing, which includes stages such as lithography patterning (masking), baking or annealing, etching, etc. Then the raw die of the chip is inserted into a package and I/O pins are connected to the package at block 118. Testing of the chip also occurs at this stage.

As shown, in the circuit design phase of block 108, the process may involve technology-independent synthesis at block 120. This step involves transferring the circuit definitions, such as register-transfer-level (RTL) descriptions, into generic data structures such as And-inverter graph (AIG), and optimizing the circuit in terms of nodes and levels. At block 122, technology mapping is performed based on information from a standard cell library 124. This step involves maps the generic optimized AIG descriptions into real, manufacturable standard cells included in the standard cell library. From this, technology-dependent synthesis is then performed at block 126. This step further optimizes the circuit defined in the gate-level netlist in terms of power, performance and area, using standard-cell-based definitions from block 122.

### Example Integrated Circuit Development System

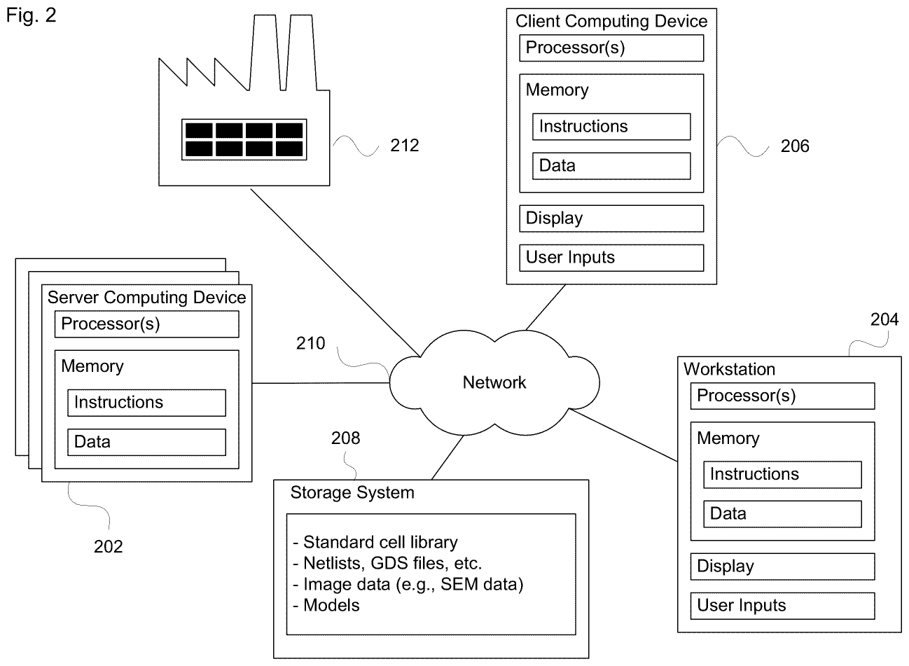

One example of a system for performing circuit design and fabrication is shown in FIG. 2. In particular, FIG. 2 is a functional diagram, of an example system 200 that includes a plurality of computing devices 202, 204, 206 and a storage system 208 connected via a network 210. System 200 may also include a fabrication facility 212 that is configured to produce integrated circuits designed according to the processes described herein. As shown in FIG. 2, each of computing devices 202, 204 and 206 may include one or more processors, memory, data and instructions.

By way of example, the one or more processors may be any conventional processors, such as commercially available central processing units (CPUs), graphical processing units (GPUs) or tensor processing unites (TPUs). Alternatively, the one or more processors may include a dedicated device such as an ASIC or other hardware-based processor. As shown in FIG. 2, the memory for each computing device stores information accessible by the one or more processors, including instructions and data that may be executed or otherwise used by the processor(s). The memory may be of any type capable of storing information accessible by the processor, including a computing device or computer-readable medium, or other medium that stores data that may be read with the aid of an electronic device, such as a hard-drive, memory card, ROM, RAM, DVD or other optical disks, as well as other write-capable and read-only memories. Systems and methods may include different combinations of the foregoing, whereby different portions of the instructions and data are stored on different types of media.

Moreover, reference to “one or more processors” herein includes situations where a set of processors may be configured to perform one or more operations. Any combination of such a set of processors may perform individual operations or a group of operations. This may include two or more CPUs, GPUs or TPUs (or other hardware-based processors) or any combination thereof. It may also include situations where the processors have multiple processing cores. Therefore, reference to “one or more processors” does not require that all processors (or cores) in the set must each perform all of the operations. Rather, unless expressly stated, any one of the one or more processors (or cores) may perform different operations when a set of operations is indicated, and different processors (or cores) may perform specific operations, either sequentially or in parallel.

The instructions may be any set of instructions to be executed directly (such as machine code) or indirectly (such as scripts) by the processor. For example, the instructions may be stored as computing device code on the computing device-readable medium. In that regard, the terms “instructions” and “programs” may be used interchangeably herein. The instructions may be stored in object code format for direct processing by the processor, or in any other computing device language including scripts or collections of independent source code modules that are interpreted on demand or compiled in advance. The instructions may include a method for processing image data of a semiconductor wafer as discussed herein.

The data may be retrieved, stored or modified by processor in accordance with the instructions. For instance, although the claimed subject matter is not limited by any particular data structure, the data may be stored in computing device registers, in a relational database as a table having a plurality of different fields and records, XML documents or flat files, HDL information, GDSII information, etc. The data may also be formatted in any computing device-readable format.

The computing devices may include all of the components normally used in connection with a computing device such as the processor and memory described above as well as a user interface having one or more user inputs (e.g., one or more of a button, mouse, keyboard, touch screen, gesture input and/or microphone), various electronic displays (e.g., a monitor having a screen or any other electrical device that is operable to display information), and speakers. The computing devices may also include a communication system having one or more wired or wireless connections to facilitate communication with other computing devices of system 200 and/or the fabrication facility 212.

The various computing devices may communicate directly or indirectly via one or more networks, such as network 210. The network 210 and any intervening nodes may include various configurations and protocols including short range communication protocols such as Bluetooth™, Bluetooth LE™, the Internet, World Wide Web, intranets, virtual private networks, wide area networks, local networks, private networks using communication protocols proprietary to one or more companies, Ethernet, WiFi and HTTP, and various combinations of the foregoing. Such communication may be facilitated by any device capable of transmitting data to and from other computing devices, such as modems and wireless interfaces.

In one example, computing device 202 may include one or more server computing devices having a plurality of computing devices, e.g., a load balanced server farm or cloud computing architecture, which exchange information with different nodes of a network for the purpose of receiving, processing, and transmitting the data to and from other computing devices. For instance, computing device 202 may include one or more server computing devices that are capable of communicating with computing devices 204, 206 and the fabrication facility 212 via the network 210. In some examples, client computing device 204 may be an engineering workstation used by a developer to perform circuit design and/or other processes for integrated circuit design and fabrication. Client computing device 206 may also be used by a developer, for instance to prepare system requirements for the integrated circuit or manage the manufacturing process with the fabrication facility 212.

Storage system 208 can be of any type of computerized storage capable of storing information accessible by the server computing devices 202, 204 and/or 206, such as a hard-drive, memory card, ROM, RAM, DVD, CD-ROM, flash drive and/or tape drive. In addition, storage system 208 may include a distributed storage system where data is stored on a plurality of different storage devices which may be physically located at the same or different geographic locations. Storage system 208 may be connected to the computing devices via the network 210 as shown in FIG. 2, and/or may be directly connected to or incorporated into any of the computing devices.

Storage system 208 may store various types of information. For instance, the storage system 208 may store image data of a semiconductor wafer and/or models of lithography processing steps with performing optimizations and other processes as well as instructions for processing image data of a semiconductor wafer and other processes described herein.

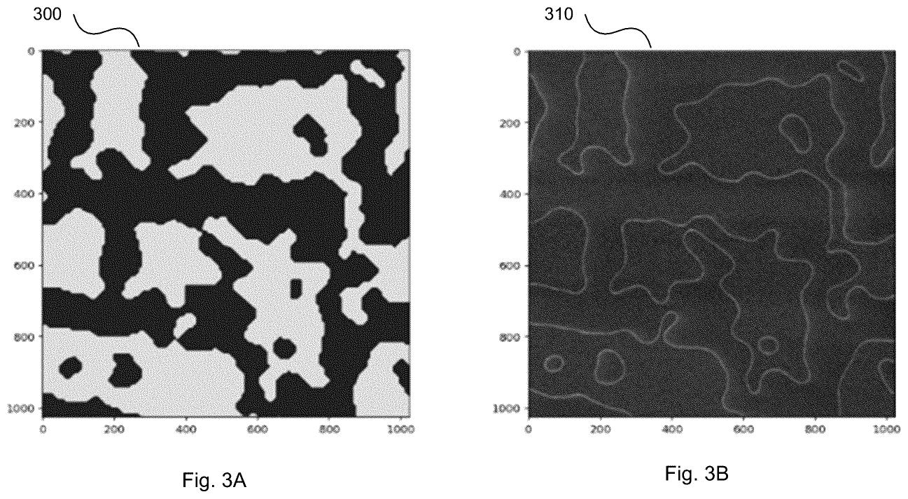

FIG. 3A illustrates an example of a target photomask design 300 in accordance with aspects of the technology. The target photomask design 300 is a portion of a larger photomask design. SEM image data may not correspond to the entirety of a fabricated wafer. That is, a SEM may only capture image data corresponding to a portion of a fabricated wafer at a time (e.g., in a single image). Thus, the target photomask design 300 corresponds to the portion of the fabricated wafer captured by the SEM image data 310. However, if SEM image data corresponds to (e.g., captures) the entirety of a fabricated wafer, then an entire photomask design can be used rather than a portion thereof as described in the examples below. The target photomask design 300 can be in GDSII or OAS format, for example.

FIG. 3B illustrates an example of SEM image data 310 corresponding to (e.g., capturing) a semiconductor wafer, or a portion thereof, in accordance with aspects of the technology. The SEM image data 310 corresponds to a portion of a semiconductor wafer having a mask pattern formed thereon according to the target photomask design 300 shown in FIG. 3A.

The approaches disclosed herein include extracting information from SEM image data from semiconductor fabrication or lithography, such as the SEM image data 310. SEM image data can be highly noisy and/or include shadows, asymmetric edges, which can make it difficult to in a consistent manner. This can include extracting information from SEM image data in a consistent manner by converting SEM image data of a wafer to a binary format or representation (e.g., a raster pattern). This converts SEM image data representing an actual, fabricated wafer, the output of a lithography processing step, to the same design space as a raster pattern that produced that fabricated wafer, the input to that lithography processing step. By being in the same design space, optimization techniques and/or modeling approaches having more degrees of freedom can be used that would not be possible with other approaches.

A non-limiting example of a binary representation of SEM image data of a wafer includes representing a pixel of the SEM image data associated with a substrate of that wafer, or a portion thereof, with a “1”. Conversely, a pixel of the SEM image data that is not associated with the substrate of that wafer, or a portion thereof, is represented with a “0”. Another non-limiting example includes representing a pixel of SEM image data associated with a substrate of a wafer, or a portion thereof, with a “0” and a pixel of the SEM image data that is not associated with the substrate, or a portion thereof, with a “1”.

A non-limiting example of a binary representation of SEM image data of a wafer includes representing a pixel of the SEM image data associated with a mask formed on that wafer, or a portion thereof, with a “1”. Conversely, a pixel of the SEM image data that is not associated with the mask, or a portion thereof, is represented with a “0”. Another non-limiting example includes representing a pixel of SEM image data associated with a mask formed on a wafer, or a portion thereof, with a “0” and a pixel of the SEM image data that is not associated with the mask, or a portion thereof, with a “1”.

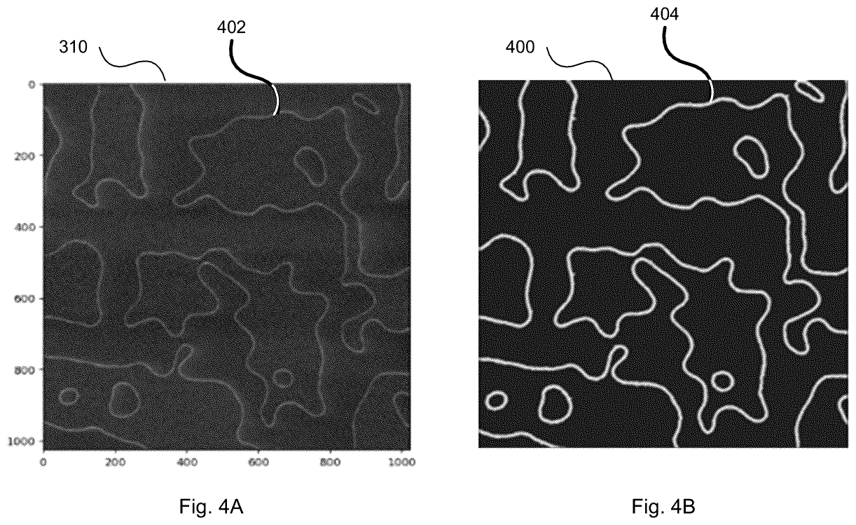

FIG. 4A illustrates an example of SEM image data 310 corresponding to (e.g., capturing) a semiconductor wafer, or a portion thereof, in accordance with aspects of the technology. FIG. 4A is a reproduction of FIG. 3B to facilitate discussion of the SEM image data 310 in relation to FIG. 4B. FIG. 4B illustrates an example of contours 400 of features of a wafer that have been extracted from the SEM image data 310 in accordance with aspects of the technology.

The approaches disclosed herein can include denoising SEM image data. Denoising SEM image data can include non-local means denoising. A calibrated adaptive image threshold can be applied to SEM image data that has been denoised using non-local means denoising. This takes various shadowing conditions within image data into account.

Extracting contours from image data of a wafer, such as the SEM image data 310, can include applying a threshold to that image data. By way of example, an adaptive threshold can be used to determine values of the threshold based on local neighborhoods. A size of a neighborhood where an adaptive threshold is determined can be calibrated and fine-tuned based on shadowing conditions and/or a resolution of the image data. A border following approach, such as any provided by the openCV library, can be used to extract contours of features of the wafer from that image data, with or without a threshold being applied to the image data. Based on that border following, contours can be drawn, such as contour 404 that corresponds to feature 402. A thickness of a drawn contour can be determined based on the size and/or curvature of a feature associated with that contour to avoid gaps and/or discontinuities in the contour. Thus, the thickness can be greater than a single pixel (e.g., between 2-5 pixels, such as 3 pixels).

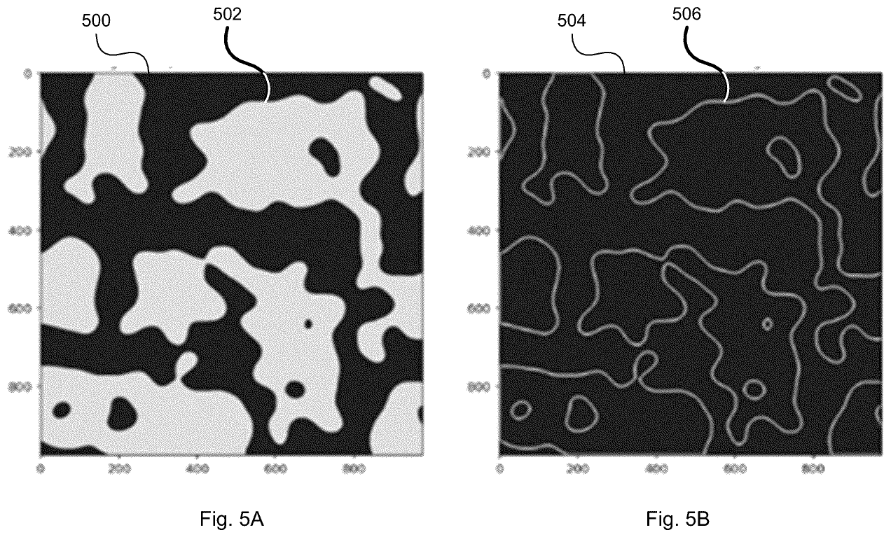

FIG. 5A illustrates an example of a smoothed target photomask design 500 in accordance with aspects of the technology. The smoothed target photomask design 500 is based the target photomask design 300 shown in FIG. 3A. The smoothed target photomask design 500 is the result from a preliminary mask-writing simulation performed using the target photomask design 300. This smooths edges of features of the target photomask design 300 (compare FIG. 3A to FIG. 5A).

FIG. 5B illustrates an example of contours 504 of wafer features extracted from the smoothed target photomask design 500. A border following approach, such as any provided by the openCV library, can be used to extract contours of features from a target photomask design. Based on that border following, contours can be drawn, such as contour 506 that corresponds to feature 502.

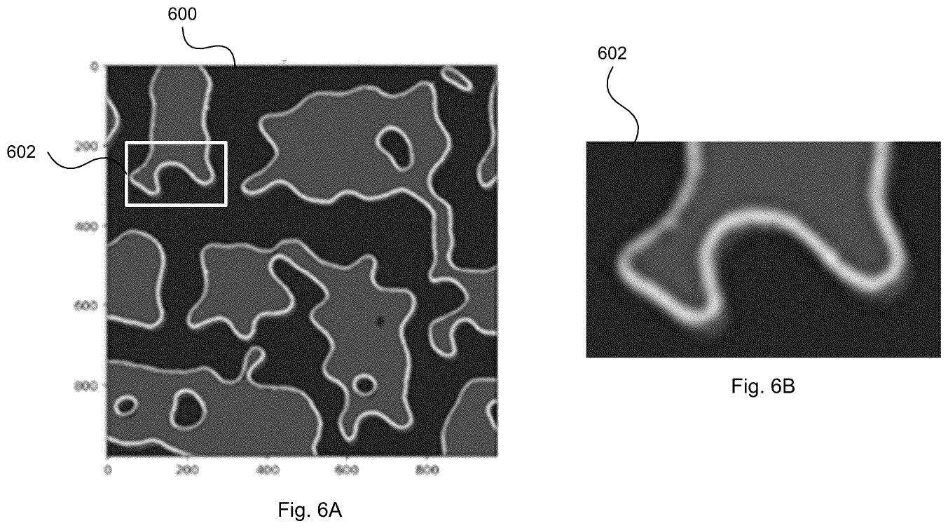

FIG. 6A illustrates an example overlay 600 of the contours 400 shown in FIG. 4B, extracted from the SEM image data 310 shown in FIG. 4A, and the contours 504 shown in FIG. 5B, extracted from the smoothed target photomask design 500 shown in FIG. 5A, in accordance with aspects of the technology. FIG. 6B illustrates an enlarged portion 602 of the overlay 600 for clarity and to demonstrate misalignment between the contours 400 extracted from the SEM image data 310 and the contours 504 extracted from the smoothed target photomask design 500. This misalignment can be caused by differences between the fabricated wafer and the result of the preliminary mask-writing simulation. To resolve this misalignment, a cross-correlation (e.g., phase cross-correlation) can be applied to determine the shift between the contours 400 extracted from the SEM image data 310 and the contours 504 extracted from the smoothed target photomask design 500. This shift can be used to align the contours 400 extracted from the SEM image data 310 and the contours 504 extracted from the smoothed target photomask design 500.

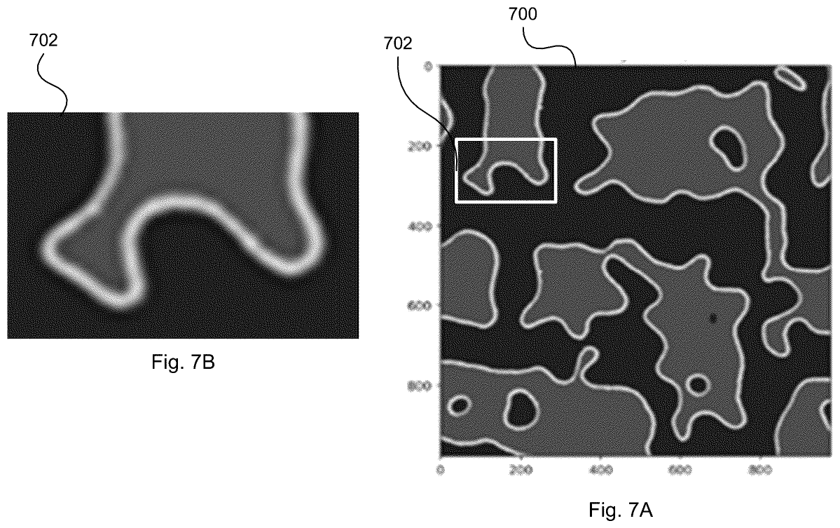

FIG. 7A illustrates an aligned example overlay of the contours 400 extracted from the SEM image data 310, and the contours 504 extracted from the smoothed target photomask design 500 in accordance with aspects of the technology. FIG. 7B illustrates an enlarged portion 702 of the aligned overlay 700. A comparison of FIG. 7A to FIG. 7B demonstrates the alignment of the contours 400 extracted from the SEM image data 310, and the contours 504 extracted from the smoothed target photomask design 500.

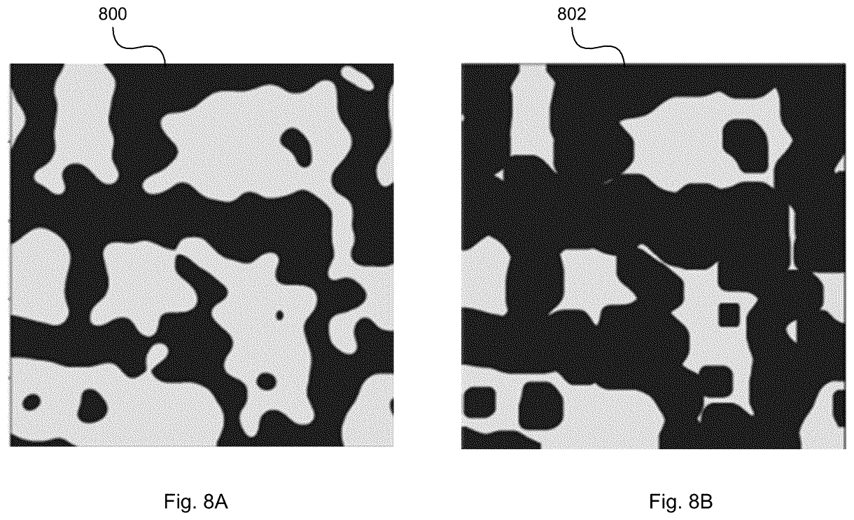

FIG. 8A illustrates an example of an aligned target photomask design 800 in accordance with aspects of the technology. The target photomask design 800 is based on the aligned contours extracted from the smoothed target photomask design 500 shown in FIG. 5A. Thus, the aligned target photomask design 800 differs from the smoothed target photomask design 500 in that the aligned target photomask design 800 differs is shifted over relative to the smoothed target photomask design 500 as a result of the cross-correlation discussed in association with FIGS. 6A-7B.

The aligned target photomask design 800 can be eroded (e.g., eroded morphologically) to generate seeds for a flood-fill of the contours 400 extracted from the SEM image data 310 shown in FIGS. 4A-B. By way of example, eroding the aligned target photomask design 800 can include using an erosion kernel. Features of the aligned target photomask design can be eroded to “shrink” the features as much as possible. By way of example, the amount of erosion can be calibrated so that features of a target photomask design are shrunken as much as possible without the erosion resulting in a threshold number of features of the target photomask design being eliminated. The amount of erosion can be based on the scale and/or size of the features. FIG. 8B illustrates an example of an eroded target photomask design 802 in accordance with aspects of the technology. The eroded target photomask design 802 is based on the aligned target photomask design 800.

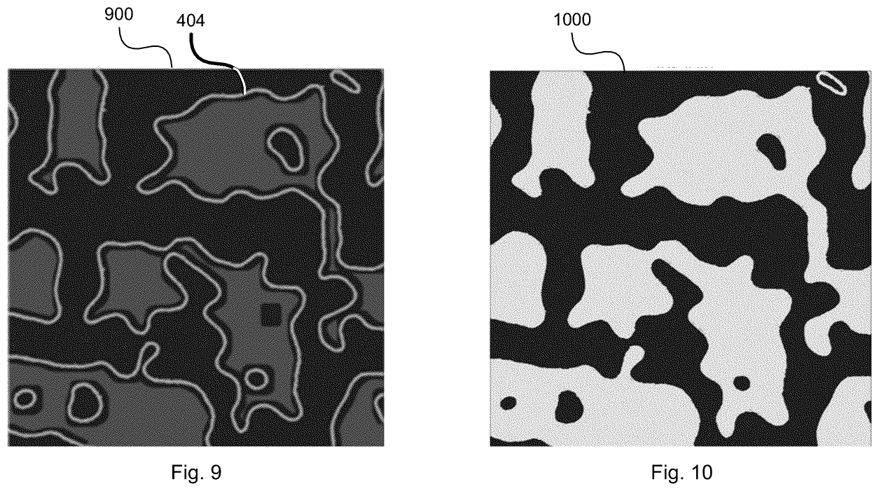

FIG. 9 illustrates an example overlay 900 of the contours 400, extracted from the SEM image data 310 shown in FIGS. 4A-B, and the eroded target photomask design 802. The features of the eroded target photomask design 802 can be used as seeds for a flood-fill of the contours 400.

FIG. 10 illustrates an example of a flood-fill 1000 based on the contours 400 in accordance with aspects of the technology. The features of the eroded target photomask design 802 are used as seeds for the flood-fill 1000.

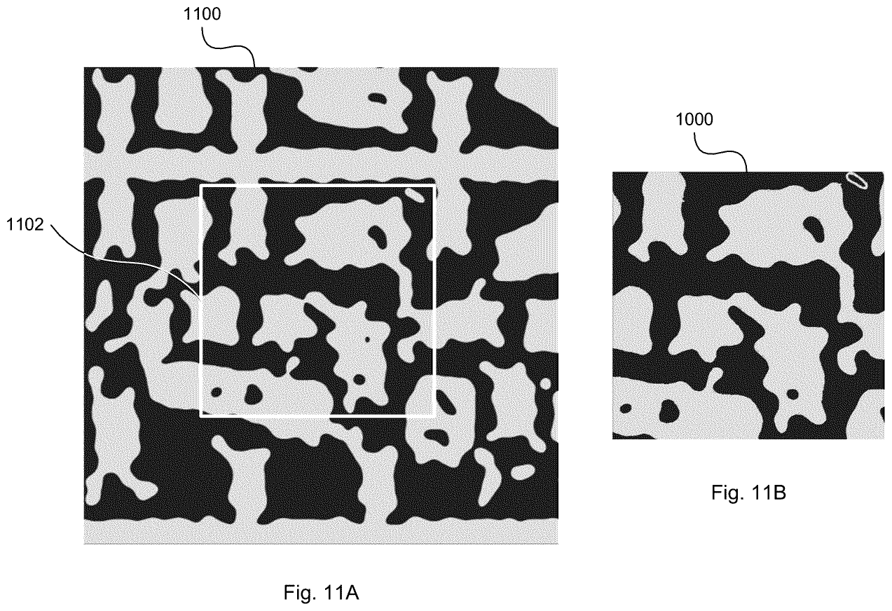

FIG. 11A illustrates an example of a photomask design 1100 including the smoothed target photomask design 500 in accordance with aspects of the technology. As described in association with FIGS. 3A-B, the target photomask design 300, on which the smoothed target photomask design 500 is based, is a portion of a larger photomask design, the photomask design 1100. By way of example, the photomask design 1100 can be the result from a preliminary mask-writing simulation performed using a corresponding photomask design in GDSII or OAS format, for example. For illustrative purposes only, box 1102 corresponds to boundaries of the smoothed target photomask design 500. At this point, the photomask design 1100 has been adjusted via cross-correlation so that the photomask design 1100 aligns with corresponding contours in image data (not shown). Contours can be extracted from the photomask design 1100 and used for modeling of lithography processes for a larger context region than the smoothed target photomask design 500.

FIG. 11B is a reproduction of the flood-fill 1000 shown in FIG. 10 to facilitate discussion of the photomask design 1100. An affine transformation can be applied to the photomask design 1100 to match the photomask design 1100 with the flood-fill 1000. FIG. 11C illustrates an affine-transformation 1104 of the photomask design 1100 to match the photomask design 1100 with the flood-fill 1000 in accordance with aspects of the technology.

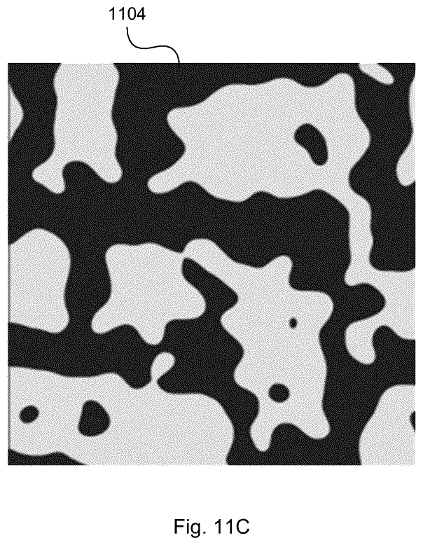

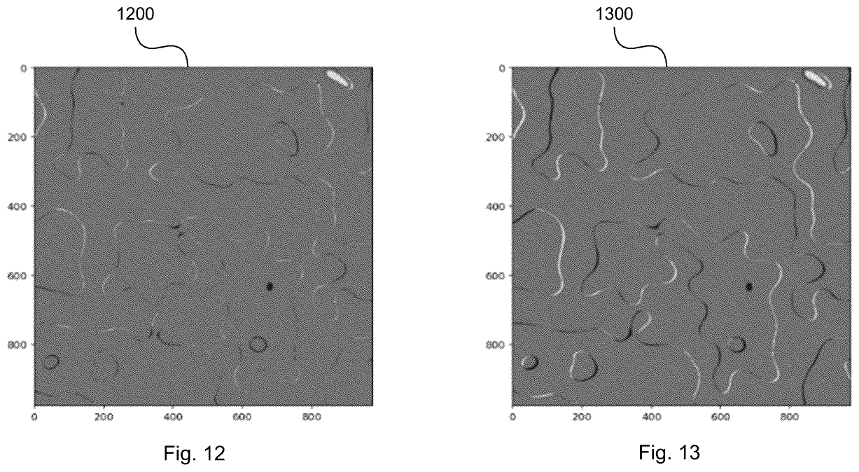

FIG. 12 illustrates an example comparison 1200 of the affine-transformed target photomask design 1104 to the contours 400 extracted from the SEM image data 310 in accordance with aspects of the technology. Specifically, the comparison 1200 shows the difference between the affine-transformed target photomask design 1104 and the contours 400.

FIG. 13 illustrates an example comparison 1300 of the aligned target photomask design 800 to the contours 400 extracted from the SEM image data 310 in accordance with aspects of the technology. Specifically, the comparison 1300 shows the difference between the aligned target photomask design 800 to the contours 400. The comparison 1300 shows a greater difference relative to the contours 400 extracted from the SEM image data 310 than the comparison 1200. This demonstrates the improved accuracy of the approaches disclosed herein to extract information from SEM image data, using flood-fills as described in association with FIGS. 8A-10.

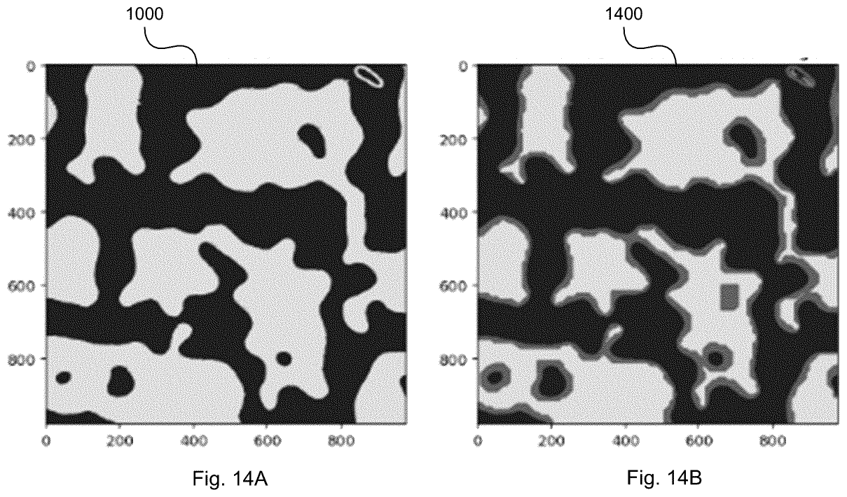

FIG. 14A is a reproduction of the affine-transformed target photomask design 1104 shown in FIG. 11B to facilitate discussion of using the affine-transformed target photomask design 1104 to generate seeds for another flood-fill in accordance with aspects of the technology. Similar to eroding the aligned target photomask design 800 to generate seeds for the flood-fill of the contours 400 extracted from the SEM image data 310 as described in association with FIGS. 8A-B, the affine-transformed target photomask design 1104 to generate seeds for another flood-fill of the contours 400. By way of example, eroding the affine-transformed target photomask design 1104 can include using an erosion kernel. However, the erosion kernel used here is smaller than the erosion kernel used in association with prior flood-fill. Thus, features of the affine-transformed target photomask design 1104 are eroded to a lesser extent than features of the aligned target photomask design 800.

FIG. 14B illustrates an overlay 1400 of an eroded version of the affine-transformed target photomask design 1104 using the smaller erosion kernel, and the contours 400 in accordance with aspects of the technology. Here, the lighter shading (blue in color) represents eroded portions of the affine-transformed target photomask design 1104 relative to the contours 400. The eroded version of affine-transformed target photomask design 1104 can be used as seeds for a flood-fill of the contours 400. This flood-fill (e.g., a second flood-fill) can capture smaller characteristics of the contours 400 not captured by the flood-fill 1000 (e.g., a first flood-fill). Because the first flood-fill 1000 uses a larger erosion kernel, features having sizes that are smaller (e.g., significantly smaller) than an average feature size may be erased. By including the second flood-fill using a smaller erosion kernel than the first flood-fill 1000, the disclosed technology applies to photomask designs having substantially varying feature sizes. Thus, the disclosed technology has greater scalability than other approaches.

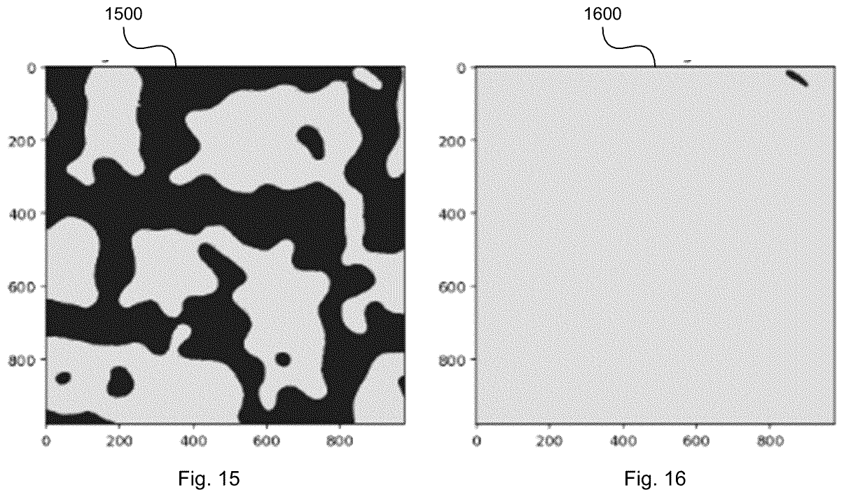

FIG. 15 illustrates an example of a combination 1500 of the flood-fill 1000 the first flood-fill) and the flood-fill based on the eroded version of the affine-transformed target photomask design 1104 (the second flood-fill) in accordance with aspects of the technology. By way of example, the first and second flood-fills can be combined via logical OR, for example. The logical OR combines the first and second flood-fills because wherever the first flood-fill 1000 or the second flood-fill indicates mask is present, the combination 1500 will indicate mask to be present. In other words, the logical OR adds whatever features captured by the second flood-fill, but not the first flood-fill 1000, to be “added onto” the first flood-fill 1000.

FIG. 16 illustrates an example of a comparison 1600 of the first flood-fill 1000 and the second flood-fill in accordance with aspects of the technology. The comparison 1600 shows that the smallest features that were eliminated (e.g., not flood-filled) by the first flood-fill 1000 are filled by the second flood-fill. Thus, the second flood-fill ensures that features at different size scales are filled.

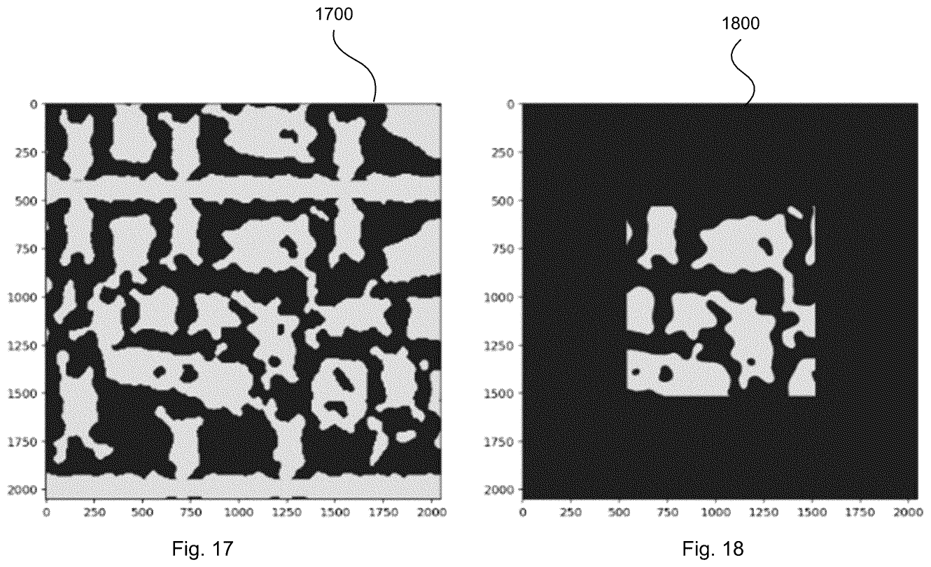

FIG. 17 illustrates an example of a photomask raster design 1700 in accordance with aspects of the technology. The photomask raster design 1700 corresponds to the photomask design 1100 shown in FIG. 11A. Because the photomask raster design 1700 is a raster design, Thus, the photomask raster design 1700 is not smooth like the photomask design 1100.

FIG. 18 illustrates an affine transformation 1800 of the second flood-fill to best match the photomask design 1100 or photomask raster design 1700 in accordance with aspects of the technology. The affine transformation 1800 results in the second flood-fill being placed on the same grid or scale as the photomask design 1100 or photomask raster design 1700. By way of example, the affine transform can enlarge and place the second flood-fill on the same scale and grid as the larger photomask design 1100 or photomask raster design 1700. This can ensure that comparisons between the larger photomask design 1100 or photomask raster design 1700, and the SEM image data 310 are accurate and do not include overlay, scaling, rotation or shear errors from measurement.

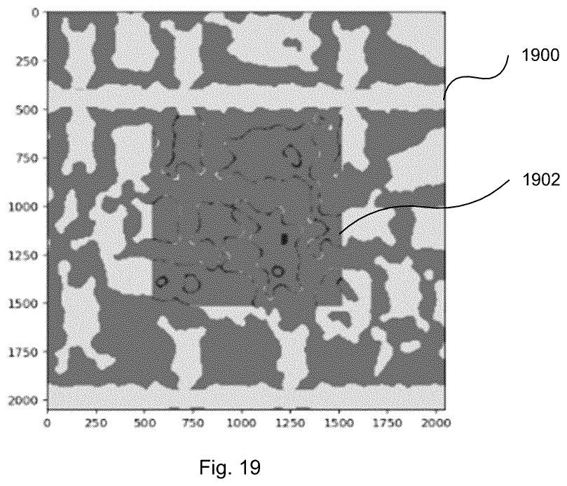

FIG. 19 illustrates a comparison 1900 (e.g., direct subtraction) of the photomask raster design 1700 shown in FIG. 17 and the affine transformation 1800 of the second flood-fill shown in FIG. 18. The central portion 1902 of the comparison 1900 can be focused on (e.g., enlarged) to capture effects of the photomask raster design 1700 on the manufactured photomask shown in the SEM image data 310, which, as discussed, captures only the center region of the manufactured photomask.

The overall process may include the following. First, a reference design of interest is obtained (e.g., obtain GDS information that is used for measuring SEM images). This may include using initial expected values of SEM extent, resolution and/or measurement locations to convert a measurement region on the GDS to a raster array. Then the process may extract contours from the SEM image. This can include denoising the SEM using non-local means denoising and applying a threshold to the image using an adaptive threshold that determines variable thresholds for local neighborhoods in the imagery. A border-following process may be performed to obtain contours of the thresholded image. The contours may be drawn with a selected thickness (e.g., on the order of 2-4 pixels, such as 3 pixels). Cross-correlation of contours is then performed for a first overlay. This can include extracting contours from a target design raster, and applying phase correlation to get a shift between the SEM contours and smoothed design contours. This is done in order to fill in the SEM contours and smoothed design contours, and to eliminate, in an automated manner, overlay, scaling, and/or other measurement errors in SEM images.

The overall process then flood-fills the SEM contours. This can be done by morphologically eroding the overall corrected design image to get seeds for flood filling the SEM with a large erosion kernel. Then the process can include rastering the larger design and match to the filled SEM image. This can include obtaining the larger design raster with desired context length, and applying affine transformation to the large design raster to match it will the filled SEM. Next, a second flood fill of SEM contours is performed. Here, the process can include eroding the affine transformed overlay photomask with a smaller kernel than the first erosion, to generate seed points for the second flood fill. Then flood fill the SEM contours with the new seeds to cover smaller missing features. Then the process can combine the first and second flood-filled SEMs. The combination of the two flood-fills can ensure filling all features at different size scales. Finally, the process may overlay the filled SEM with the reference design of interest. Here, if extended context is required for optimization, the process may affine transform the filled SEM to the large design raster to overlay the matching regions. This allows kernels to be optimized on the larger design raster, thereby making these kernels aware of the larger context of the photomask design so as to take the impact of the larger context of the photomask design into action. A loss can be computed from the padded and overlaid SEM.

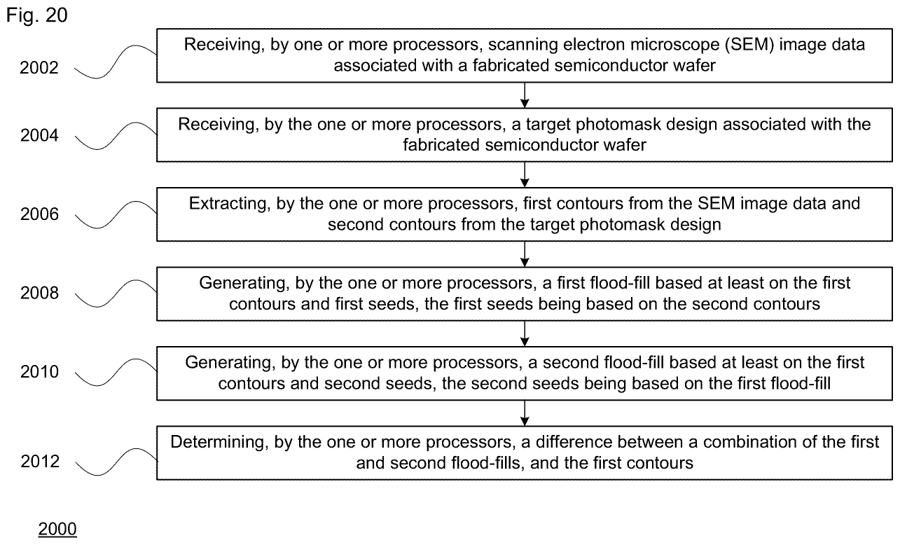

FIG. 20 illustrates an example method 2000 in accordance with the above discussion. The method 2000 includes, at block 2002, receiving, by one or more processors, SEM image data associated with a fabricated semiconductor wafer. At block 2004, the method 2000 includes receiving, by the one or more processors, a target photomask design associated with the fabricated semiconductor wafer. At block 2006, the method 2000 includes extracting, by the one or more processors, first contours from the SEM image data and second contours from the target photomask design. At block 2008, the method 2000 includes generating, by the one or more processors, a first flood-fill based at least on the first contours and first seeds, the first seeds being based at least on the second contours. At block 2010, the method 2000 includes generating, by the one or more processors, a second flood-fill based at least on the first contours and second seeds, the second seeds being based at least on the first flood-fill. At block 2012, the method 2000 includes determining, by the one or more processors, a difference between a combination of the first and second flood-fills, and the first contours.

Although the technology herein has been described with reference to particular embodiments and configurations, it is to be understood that these embodiments and configurations are merely illustrative of the principles and applications of the present technology. It is therefore to be understood that numerous modifications may be made to the illustrative embodiments and configurations, and that other arrangements may be devised without departing from the spirit and scope of the present technology as defined by the appended claims.

1. A method comprising:
receiving, by one or more processors, scanning electron microscope (SEM) image data associated with a fabricated semiconductor wafer;
receiving, by the one or more processors, a target photomask design associated with the fabricated semiconductor wafer;
extracting, by the one or more processors, first contours from the SEM image data and second contours from the target photomask design;
generating, by the one or more processors, a first flood-fill based at least on the first contours and first seeds, the first seeds being based at least on the second contours;
generating, by the one or more processors, a second flood-fill based at least on the first contours and second seeds, the second seeds being based at least on the first flood-fill; and
determining, by the one or more processors, a difference between a combination of the first and second flood-fills, and the first contours.

2. The method of claim 1, wherein extracting the first contours includes:
denoising, by the one or more processors, the SEM image data;
converting, by the one or more processors, the denoised SEM image data to a binary format; and
applying, by the one or more processors, a border following approach to the converted, denoised SEM image data.

3. The method of claim 1, wherein:
generating the first flood-fill includes aligning the first contours with the second contours, and
generating the first flood-fill is further based at least on the aligned first contours.

4. The method of claim 1, wherein generating the first flood-fill includes generating the first seeds by eroding, by the one or more processors, the target photomask design.

5. The method of claim 1, wherein generating the second flood-fill includes generating the second seeds by eroding, by the one or more processors, an affine transformation of the target photomask design based at least on the first flood-fill.

6. The method of claim 1, wherein:
generating the first flood-fill includes generating the first seeds by eroding, by the one or more processors based at least on a first kernel, the target photomask design,
generating the second flood-fill includes generating the second seeds by eroding, by the one or more processors based at least on a second kernel, an affine transformation of the target photomask design based at least on the first flood-fill, and
the second kernel is smaller than the first kernel.

7. The method of claim 6, wherein the second kernel is smaller than the first kernel by a selected amount.

8. The method of claim 1, wherein determining the difference includes applying, by the one or more processors, an affine transformation to the combination of the first and second flood-fills.

9. The method of claim 1, further comprising training, by the one or more processors based at least on the determined difference, a machine learning model to adjust the target photomask design.

10. The method of claim 1, further comprising adjusting, by the one or more processors based at least on the determined difference, the target photomask design.

11. A system comprising:
memory configured to store at least one of scanning electron microscope (SEM) image data associated with a fabricated semiconductor wafer and a target photomask design associated with the fabricated semiconductor wafer; and
one or more processors operatively coupled to the memory, the one or more processors being configured to:
extract first contours from the SEM image data and second contours from the target photomask design;
generate a first flood-fill based at least on the first contours and first seeds, the first seeds being based at least on the second contours;
generate a second flood-fill based at least on the first contours and second seeds, the second seeds being based at least on the first flood-fill; and
determine a difference between a combination of the first and second flood-fills, and the first contours.

12. The system of claim 11, wherein the one or more processors are configured to extract the first contours by being configured to:
denoise the SEM image data;
convert the denoised SEM image data to a binary format; and
applying a border following approach to the converted, denoised SEM image data.

13. The system of claim 11, wherein the one or more processors are further configured to:
align the first contours with the second contours; and
generate the first flood-fill is further based at least on the aligned first contours.

14. The system of claim 11, wherein the one or more processors are further configured to generate the first seeds by erosion of the target photomask design.

15. The system of claim 11, wherein the one or more processors are further configured to generate the second seeds by erosion of an affine transformation of the target photomask design based at least on the first flood-fill.

16. The system of claim 11, wherein the one or more processors are further configured to:
generate the first seeds by erosion, based at least on a first kernel, of the target photomask design; and
generate the second seeds by erosion, based at least on a second kernel, of an affine transformation of the target photomask design based at least on the first flood-fill, the second kernel being smaller than the first kernel.

17. The system of claim 16, wherein the second kernel is smaller than the first kernel by a selected amount.

18. The system of claim 11, wherein the one or more processors are configured to determine the difference by being configured to apply an affine transformation to the combination of the first and second flood-fills.

19. The system of claim 11, wherein the one or more processors are further configured to train, based at least on the determined difference, a machine learning model to adjust the target photomask design.

20. The system of claim 11, wherein the one or more processors are further configured to adjust, based at least on the determined difference, the target photomask design.
